(19) United States
(12) Patent Application Publication
(10) Pub. No.: US 2008/0203355 A1
(43) Pub. Date: Aug. 28, 2008

(54) Method for Producing Salts of Hydrocyanic Acid

(75) Inventors: Andreas Deckers, Flomborn (DE); Thomas Schneider, Frankenthal (DE); Helmuth Menig, Friedelsheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/916,915

(22) PCT Filed: May 31, 2006
(86) PCT No.: PCT/EP2006/062751

§ 371 Date: Dec. 7, 2007

(30) Foreign Application Priority Data
Jun. 7, 2005 (DE) 10 2005 026 326.7

(51) Int. Cl. C09K 3/00

(52) U.S. Cl. 252/182.34

(57) ABSTRACT

The present application relates to a process for preparing a solution of cyanide salts, comprising the steps of:
a) preparing a crude gas comprising hydrocyanic acid by dehydrating formamide up to a formamide conversion of ≧97%;
b) if appropriate, acid-scrubbing the crude gas obtained in step a);
c) subsequently reacting the crude gas obtained in step a) or, if appropriate, in step b) with an aqueous solution of a hydroxide, M(OH)ₓ, where M is selected from the group consisting of alkali metals and alkaline earth metals and x is dependent upon the oxidation state of M and is 1 or 2.

The present invention relates to a process for preparing a solution of cyanide salts, comprising the preparation of a crude gas comprising hydrocyanic acid by dehydrating formamide, if appropriate subjecting the resulting crude gas to acid scrubbing and subsequent reaction of the resulting crude gas with a metal hydroxide, M(OH)ₓ.

Cyanide salts, especially sodium and potassium cyanide, find wide use for producing various chemical products such as complexing agents, caffeine precursors, and pharmaceutical precursors. In addition, cyanide salts, especially sodium cyanide and also calcium cyanide, are used in large amounts for the extraction of gold by cyanide leaching from ores.

The preparation of cyanide salts by neutralizing hydrocyanic acid with metal hydroxides, especially alkali metal hydroxides such as sodium hydroxide, in aqueous solutions is known to those skilled in the art. Hydrocyanic acid can be neutralized by first isolating the hydrocyanic acid from the crude process gas in pure form, condensing it and then reacting it with metal hydroxides in the liquid phase. Although the resulting cyanide salt is very pure and an about 30% by weight solution in water has virtually no intrinsic color, the above-described procedure is technically and energetically very complex.

In order to be able to operate the reaction of hydrocyanic acid with metal hydroxides with a lower level of apparatus complexity, in which case it is likewise possible to reduce the energy consumption, it is advantageous to prepare the cyanide salts by directly reacting crude process gas with metal hydroxides without isolation of pure hydrocyanic acid.

For instance, U.S. Pat. No. 4,847,062 relates to a process for preparing sodium cyanide crystals by reacting crude gas which comprises hydrocyanic acid and is prepared by means of the Andrussow process, comprising oxides of carbon and water, with sodium hydroxide. The concentration of sodium hydroxide is high enough to absorb the hydrocyanic acid and to prevent the polymerization of hydrocyanic acid but low enough to prevent reaction of sodium carbonate, which is formed by reaction of the oxides of carbon with sodium hydroxide, with the hydrocyanic acid. The resulting sodium cyanide is subsequently isolated from the sodium cyanide solution in the form of crystals.

U.S. Pat. No. 3,619,132 relates to a process for preparing alkali metal cyanides by reacting a carbon dioxide-free crude gas comprising hydrocyanic acid with aqueous alkali metal hydroxide in a first step at a pressure below atmospheric pressure to form the alkali metal cyanide, and subsequent crystallization of the alkali metal cyanide in a second step at a pressure below the pressure in the first step. The hydrocyanic acid can be obtained according to U.S. Pat. No. 3,619,132 by means of various processes, for example from carbon monoxide and ammonia, from formamide or from hydrocarbons and ammonia.

Typically, hydrocyanic acid is prepared industrially by reacting hydrocarbons, especially methane, with ammonia (Andrussow process, BMA process). Both in the Andrussow process and in the BMA process, the use of a noble metal catalyst is necessary.

Another means of preparing hydrocyanic acid is the dehydration of formamide. In this case, initially methanol and methyl formate are prepared from synthesis gas (CO/H₂), the methyl formate then being transamidated with ammonia to formamide. The formamide is thermally labile and decomposes at high temperatures to hydrocyanic acid and water. This cleavage is very selective. In this way, a cleavage gas is obtainable which has a high concentration of hydrocyanic acid and also merely small amounts of ammonia or other gaseous substances such as CO₂, CO or H₂. Moreover, the process for preparing hydrocyanic acid by dehydrating formamide has the advantage that no expensive noble metal catalyst has to be used, and that the process has a low level of apparatus complexity.

Processes for preparing hydrocyanic acid by dehydrating formamide are specified, for example, in EP-A 0 209 039, DE-A 101 385 53 and WO 2004/050587.

The dehydration of formamide under reduced pressure proceeds by the following equation (I):

HCONH₂→HCN+H₂O (I).

EP-A 0 209 039 discloses a process for thermolytically cleaving formamide in the presence of atmospheric oxygen over highly sintered aluminum oxide or aluminum oxide-silicon oxide shaped bodies or over chromium-nickel-stainless steel shaped bodies resistant to corrosion at high temperature.

DE-A 101 385 53 relates to a process for preparing hydrocyanic acid by catalytically dehydrating gaseous formamide in the presence of atmospheric oxygen, the process being performed in the presence of a catalyst comprising iron in the form of metallic iron and/or iron oxide.

WO 2004/050587 relates to a process for preparing hydrocyanic acid by catalytically dehydrating gaseous formamide in a reactor which has an inner reactor surface composed of a steel comprising iron and also chromium and nickel, and also to a reactor for preparing hydrocyanic acid by catalytic dehydration of gaseous formamide, the reactor having an inner reactor surface composed of a steel comprising iron and also chromium and nickel.

A preparation process for preparing solutions of cyanide salts starting from hydrocyanic acid which has been obtained by dehydrating formamide is not disclosed in EP-A 0 209 039, DE-A 101 385 53 and WO 2004/050587.

It is desirable to prepare solutions of cyanide salts which have a high purity, especially solutions which have minimal or no intrinsic color.

Such solutions of cyanide salts shall be prepared in a process which does not have any costly and inconvenient purification steps.

The present application therefore provides a process for preparing solutions of cyanide salts which have minimal intrinsic color with avoidance of costly and inconvenient purification steps.

This object is achieved by a process for preparing a solution of cyanide salts, comprising the steps of:
a) preparing a crude gas comprising hydrocyanic acid by dehydrating formamide up to a formamide conversion of ≧97%, preferably ≧97.5%, more preferably ≧98%;
b) if appropriate, acid-scrubbing the crude gas obtained in step a);
c) subsequently reacting the crude gas obtained in step a) or, if appropriate, in step b) with an aqueous solution of a metal hydroxide, M(OH)ₓ, where M is selected from the group consisting of alkali metals and alkaline earth metals and x is dependent upon the oxidation state of M and is 1 or 2.

The formamide conversion in step a) of the process according to the invention was determined by IR spectroscopy by determining the amount of formamide in the process gas.

The aqueous solutions of the cyanide salts obtained in step c) have no or merely low intrinsic color. The color number of aqueous solutions which are prepared by the process according to the invention is generally ≦40 APHA, preferably ≦25 APHA, more preferably ≦6 APHA. The color number is measured on aqueous solutions which have a content of the cyanide salt prepared of 30% by weight. The APHA color number is determined to DIN 53409 (determination of the Hazen color number; APHA method).

It has been found that, surprisingly, aqueous cyanide salt solutions with low intrinsic color, especially with an APHA color number as mentioned above, are obtained when a particularly high formamide conversion is attained in step a) of the process according to the invention. At a formamide conversion of <97%, aqueous cyanide salt solutions are obtained which have significantly higher APHA color numbers.

### Step a)

In step a), a crude gas comprising hydrocyanic acid is initially prepared. This is prepared in the present invention by dehydrating formamide, preferably gaseous formamide, up to a formamide conversion of ≧97%, preferably ≧97.5%, more preferably ≧98%. Formamide can be dehydrated by any process known to those skilled in the art with which a formamide conversion of at least 97% can be attained.

In general, the crude gas obtained in step a) comprises a maximum of 3.0% by weight of formamide, preferably a maximum of 2.5% by weight of formamide, more preferably a maximum of 2.0% by weight of formamide. The amount of formamide is determined by IR spectroscopy.

Suitable processes are specified, for example, in EP-A 0 209 039, DE-A 101 385 53 and WO 2004/050587. The process proceeds generally in accordance with equation (I) which is stated above.

The formamide used may be obtained, for example, by first preparing methanol and methyl formate from synthesis gas (CO/H₂) and then transamidating the methyl formate with ammonia to give formamide.

In one embodiment, step a) may be carried out in such a way that liquid formamide is evaporated in a heat exchanger, especially in a tube bundle heat exchanger, under a pressure of generally from 1 to 350 mbar and at temperatures of generally from 80 to 200° C. Still within the evaporator tube, the formamide vapors are heated generally to temperatures of from 300 to 480° C. However, the possibility also exists of superheating the formamide vapor to temperatures of from 300 to 480° C. by means of a tube bundle heat exchanger.

Preference is given to subsequently adding air or oxygen to the resulting formamide vapors in an amount of from 5 to 100 kg of air/1000 kg, preferably from 20 to 80 kg of air/1000 kg of formamide vapor. The air fraction or the oxygen fraction may, if appropriate, be added in the preheated state. This oxygen or air supply serves both to increase the formamide conversion and to increase the HCN selectivity.

The formamide vapors or, if air or oxygen has been added, the formamide-air or -oxygen mixture are, in the actual cleavage of the formamide in a reactor, preferably in a tubular reactor, most preferably in a multitube reactor, heated to temperatures of from 300 to 650° C., preferably from 450 to 600° C., more preferably from 500 to 540° C.

The reactors used are tubular reactors, especially multitube reactors, preference being given to using a reactor which has an inner reactor surface composed of a steel comprising iron and also chromium and nickel. Such a reactor is disclosed, for example, in WO 2004/050587. When this reactor is used, there is no need to use further catalysts or internals.

However, it is also possible to use other reactors known to those skilled in the art in step a) of the process according to the invention. It is also possible, in the process according to step a), to use catalysts or internals as disclosed, for example, in EP-A 0 209 039, in which highly sintered shaped bodies consisting of from 50 to 100% by weight of aluminum oxide and from 50 to 0% by weight of silicon dioxide, or chromium-nickel-stainless steel shaped bodies resistant to corrosion at high temperature are used, or catalysts as disclosed in DE-A 101 385 53, in which a catalyst is used which comprises iron in any form, preferably in the form of metallic iron and/or as iron oxide. These catalysts may be introduced into the reactor in the form of random packings or in a structured packing, for example in the form of a static mixer made of steel.

The pressure in step a) of the process according to the invention is generally from 30 to 350 mbar, preferably from 50 to 250 mbar, more preferably from 100 to 250 mbar.

The mean residence time of the formamide on the reactor surface is generally from 0.01 to 0.25 s, preferably from 0.01 to 0.15 s.

Step a) of the process according to the invention can be conducted in a wide loading range. In general, the superficial loading is from 1 to 100 kg of formamide/m² of reactor surface area, preferably from 5 to 80 kg of formamide/m² of reactor surface area, more preferably from 10 to 50 kg of formamide/m² of reactor surface area.

### Step b)

If the formamide cleavage in step a) is very selective, a crude gas is obtained which, in addition to water, has a high concentration of hydrocyanic acid and also only small amounts of ammonia or other gaseous substances such as CO₂, CO and H₂. The crude gas obtained in step a) can therefore be used directly in step c) to obtain cyanide salt solutions with only low intrinsic color, if any.

However, it is also possible to wash out the ammonia formed in small amounts in step a) by acid scrubbing before the reaction in step c). The acid used may be any mineral acid, preferably sulfuric acid or phosphoric acid.

Acid scrubbing of formamide-containing crude gases is known to those skilled in the art and can be performed by processes known to those skilled in the art (Ullmann's Encyclopedia of Industrial Chemistry 6th edition, chapter HCN). Particular preference is given to scrubbing with sulfuric acid, very particular preference to scrubbing with concentrated sulfuric acid (95-96% by weight H₂SO₄).

The sulfuric acid scrubbing is generally performed in such a way that the crude gas obtained in step a) is passed through concentrated sulfuric acid. This generally has the temperature of from 5 to 40° C., preferably from 10 to 30° C., more preferably from 15 to 25° C.

### Step c)

In step c), the crude gas obtained in step a) is reacted (neutralized), or, if appropriate, the crude gas obtained in step b) is reacted, with a metal hydroxide.

The metal hydroxide used is a hydroxide of the formula M(OH)ₓ where M is selected from the group consisting of alkali metals and alkaline earth metals, x is dependent upon the oxidation state of M and is 1 or 2.

Alkali metals used with preference are Li, Na and K, more preferably Na and K, most preferably Na. Alkaline earth metals used with preference are Mg and Ca, more preferably Ca. The hydroxide used is more preferably a hydroxide in which M is Na or K and x is 1. Preferred hydroxides are thus NaOH and KOH, very particular preference being given to NaOH. It will be appreciated that it is also possible to use mixtures of different metal hydroxides.

The hydroxide is used in the form of an aqueous solution.

In step c), very particular preference is thus given to using a solution of NaOH or KOH in water. Especially preferred is a solution of NaOH in water.

The solution of the hydroxide comprises generally from 5 to 50% by weight, preferably from 15 to 50% by weight, more preferably from 30 to 50% by weight of the hydroxide used.

The reaction in step c) is performed generally at temperatures of from 5 to 100° C., preferably from 10 to 80° C., more preferably from 20 to 60° C.

Step c) is carried out generally by passing the crude gas which is obtained in step a) or, if appropriate, in step b) and comprises hydrocyanic acid into an aqueous solution which comprises a hydroxide M(OH)ₓ. Preferred hydroxides have already been specified above.

In general, crude gas comprising hydrocyanic acid is introduced into the solution comprising the hydroxide until an excess of hydroxide of generally from 0.1 to 5% by weight, preferably from 0.2 to 2.0% by weight, is attained. When this excess of hydroxide has been attained, the introduction of the crude gas comprising hydrocyanic acid is stopped.

A solution of the desired cyanide salt in water is obtained. The content of cyanide salts in the solution is dependent upon the amount of hydroxide used in the solution.

In general, a solution is obtained which a content of desired cyanide salt of from 5 to 40% by weight, preferably from 15 to 35% by weight, more preferably from 25 to 35% by weight.

The resulting solution comprising the desired cyanide salt has an APHA color number (to DIN 53 409) of generally ≦40, preferably ≦25, more preferably ≦6.

Such low color numbers are attained only when a crude gas comprising hydrocyanic acid is used which is prepared in step a) of the process according to the invention, which means that the formamide conversion in step a) is ≧97%, preferably ≧97.5%, more preferably ≧98%. At lower formamide conversions, solutions of cyanide salts are obtained which have significantly higher color numbers, as is shown in the appended examples.

In a preferred embodiment, step c) of the process according to the invention is carried out in such a way that the crude gas which comprises hydrocyanic acid and is obtained in step a) or, if appropriate, in step b) is passed with a temperature of generally from 60 to 150° C., preferably from 80 to 120° C., more preferably from 90 to 110° C., into a vessel, for example a stirred vessel. The vessel is initially charged with an aqueous solution comprising a hydroxide, preferred hydroxides and amounts of hydroxides being those specified above. Step c) (neutralization) is performed generally at the aforementioned temperatures, and it is possible, for example, to cool the vessel externally. Preference is given to regularly monitoring the content of free hydroxide by sampling, and to stopping the gas introduction at the aforementioned excess of hydroxide.

However, it is likewise possible and comprised by the present invention to perform the process according to the invention continuously or semicontinuously. Suitable apparatus and process conditions for the continuous or semicontinuous performance of the process according to the invention, for example trickle columns filled with internals (random packings, structured packings, etc) with external cooling are known to those skilled in the art.

The solutions obtained in the process according to the invention can be diluted further by adding further aqueous solvent or concentrated by suitable processes known to those skilled in the art. It is likewise possible to isolate the cyanide salt obtained in solution. Suitable processes for isolating the cyanide salt are known to those skilled in the art.

The solutions obtained by the process according to the invention are preferably used further directly or after slight further dilution. Most preferably, the content of cyanide salts in the solutions provided for further use is from 10 to 40% by weight, preferably from 15 to 35% by weight, more preferably from 30 to 35% by weight.

The examples which follow provide additional illustration of the invention.

### EXAMPLES

### A Preparation of a Crude Gas Comprising Hydrocyanic Acid

### Example A1 (Inventive)

A 4.5 m-long reaction tube made of 1.4541 steel (V2A steel) with an internal diameter of 10 mm and an external diameter of 12 mm is brought electrically to a constant external temperature of 520° C. The reaction tube has a specific surface area of 400 m²/m³. The internal pressure in the tube is 100 mbar abs. and is generated by a vacuum pump.

In an upstream evaporator which is likewise under the reaction pressure, 1.3 kg/h of formamide are evaporated at 145° C. and passed to the top of the reaction tube. In addition, 13 l (STP) of air/h are fed in at the connection between evaporator and reaction tube.

At the end of the reaction tube, a sample is taken and analyzed for its constituents. The analysis gave a conversion of formamide of 98.5% and a hydrocyanic acid selectivity based on formamide of 93.2%.

### Example A2 (Comparative Example)

A 4.5 m-long reaction tube made of 1.4541 steel (V2A steel) with an internal diameter of 10 mm and an external diameter of 12 mm is brought electrically to a constant external temperature of 500° C. The reaction tube has a specific surface area of 400 m²/m³. The internal pressure in the tube is 200 mbar abs. and is generated by a vacuum pump.

In an upstream evaporator which is likewise under the reaction pressure, 2.4 kg/h of formamide are evaporated at 185° C. and passed to the top of the reaction tube. In addition, 18 l (STP) of air/h are fed in at the connection between evaporator and reaction tube.

At the end of the reaction tube, a sample is taken and analyzed for its constituents. The analysis gave a conversion of formamide of 94.0% and a hydrocyanic acid selectivity based on formamide of 93.8%.

### B Preparation of Cyanide Salt Solutions

### Example B1a (Inventive)

For preparing the crude gas comprising hydrocyanic acid: example A1 (formamide conversion: 98.5%; hydrocyanic acid selectivity: 93.2%).

The composition of the crude gas obtained in example A1 is as follows (in % by weight): 55.5% HCN; 38.0% water; 1.5% formamide; 1.7% NH₃; 2.9% CO₂; 0.2% H₂; 0.2 CO.

For NH₃ removal, the crude gas is passed through cooled (20° C.) concentrated sulfuric acid. The crude gas obtained in this way does not comprise any detectable NH₃.

The neutralization is effected by passing the crude gas comprising HCN (temperature of the crude gas: 100° C.) into a 25 l stirred vessel in which about 10 l of a 40% by weight aqueous NaOH solution are initially charged. During the neutralization at 40° C. (external cooling), the content of free NaOH is monitored constantly (sampling). At an excess of about 0.5% NaOH, the gas introduction is stopped. Small amounts of water are used to establish a cyanide content of 30% by weight. The cyanide liquor thus obtained has an APHA color number of 1.

### Example B2b (Comparative Example)

Process for preparing the crude gas comprising hydrocyanic acid: example A2 (formamide conversion: 94.0%; hydrocyanic acid selectivity: 93.8%).

The composition of the crude gas obtained in example A2 is as follows (in % by weight): 53.0% HCN; 36.0% water; 6.0% formamide; 1.7% NH₃; 2.9% CO₂; 0.2% H₂; 0.2 CO.

For NH₃ removal, the crude gas is passed through cooled (20° C.) concentrated sulfuric acid. The crude gas obtained in this way does not comprise any detectable NH₃.

The neutralization is effected by passing the crude gas comprising HCN (temperature of the crude gas: 100° C.) into a 25 l stirred vessel in which about 10 l of a 40% by weight aqueous NaOH solution are initially charged. During the neutralization at 40° C. (external cooling), the content of free NaOH is monitored constantly (sampling). At an excess of about 0.5% NaOH, the gas introduction is stopped. Small amounts of water are used to establish a cyanide content of 30% by weight. The cyanide liquor thus obtained has an APHA color number of 55.

TABLE 1
lists further inventive examples and comparative examples.

| | | Con- | | | | | | | | Color |
|---|---|---|---|---|---|---|---|---|---|---|
| | No. | version³⁾ | HCN⁴⁾ | H₂O⁵⁾ | FA⁶⁾ | NH₃⁷⁾ | CO₂⁸⁾ | CO⁹⁾ | H₂¹⁰⁾ | No.¹¹⁾ |
| Inventive | B1a | 98.5 | 55.5 | 38.0 | 1.5 | 1.7 | 2.9 | 0.2 | 0.2 | 1 |
| Inventive | B1b¹⁾ | 98.1 | 55.3 | 37.9 | 1.9 | 1.6 | 2.8 | 0.2 | 0.2 | 6 |
| Inventive | B1c¹⁾ | 97.1 | 54.9 | 37.8 | 2.9 | 1.5 | 2.6 | 0.2 | 0.2 | 25 |
| Com- | B2a²⁾ | 96.2 | 54.5 | 37.3 | 3.8 | 1.5 | 2.5 | 0.2 | 0.1 | 45 |
| parative | | | | | | | | | | |
| Com- | B2b | 94 | 53.0 | 36.3 | 6.0 | 1.7 | 2.7 | 0.2 | 0.2 | 55 |
| parative | | | | | | | | | | |
| Com- | B2c²⁾ | 90.5 | 51.7 | 35.4 | 9.5 | 1.4 | 1.8 | 0.1 | 0.1 | 85 |
| parative | | | | | | | | | | |

¹⁾Examples B1b and B1c are performed analogously to example B1a, except that a crude gas comprising hydrocyanic acid which has the composition specified in table 1 is used in each case;
²⁾Examples B2a and B2c are performed analogously to example B2b, except that a crude gas comprising hydrocyanic acid which has the composition specified in table 1 is used in each case;
³⁾Formamide conversion [%];
⁴⁾Content of HCN in the crude gas used [% by weight];
⁵⁾Content of H₂O in the crude gas used [% by weight];
⁶⁾Content of formamide (FA) in the crude gas used [% by weight];
⁷⁾Content of NH₃ in the crude gas used [% by weight];
⁸⁾Content of CO₂ in the crude gas used [% by weight];
⁹⁾Content of CO in the crude gas used [% by weight];
¹⁰⁾Content of H₂ in the crude gas used [% by weight];
¹¹⁾APHA color number of a 30% by weight solution in water (to DIN 53 409)

Table 1 makes clear that, at a formamide conversion of <97%, solutions of cyanide salts are obtained which have a significantly higher APHA color number than the solutions which are prepared starting from a crude gas comprising hydrocyanic acid, the formamide conversion being ≧97%.

1-10. (canceled)

11. A process for preparing a solution of cyanide salts, comprising the steps of:
a) preparing a crude gas comprising hydrocyanic acid by dehydrating formamide up to a formamide conversion of ≧97%;
b) if appropriate, acid-scrubbing the crude gas obtained in step a);
c) subsequently reacting the crude gas obtained in step a) or, if appropriate, in step b) with an aqueous solution of a hydroxide, M(OH)x, where M is selected from the group consisting of alkali metals and alkaline earth metals and x is dependent upon the oxidation state of M and is 1 or 2.

12. The process according to claim 11, wherein the hydrocyanic acid is prepared in the presence of air or oxygen.

13. The process according to claim 11, wherein step a) of the process is carried out at from 300 to 650° C.

14. The process according to claim 11, wherein the superficial loading is from 1 to 100 kg of formamide/m² of reactor surface area.

15. The process according to claim 11, wherein step a) of the process is performed in a reactor which has an inner reactor surface composed of a steel comprising iron and also chromium and nickel.

16. The process according to claim 11, wherein the acid scrubbing in step b) is a sulfuric acid scrubbing.

17. The process according to claim 11, wherein M in step c) of the process is an alkali metal selected from Li, Na and K and x is 1.

18. The process according to claim 11, wherein the hydroxide in step c) of the process is NaOH.

19. The process according to claim 11, wherein the aqueous solution of the hydroxide in step c) of the process comprises from 5 to 50% by weight of the hydroxide.

20. The process according to claim 11, wherein the reaction in step c) is carried out at from 5 to 100° C.
